(19) United States
(12) Patent Application Publication
(10) Pub. No.: US 2023/0230133 A1
(43) Pub. Date: Jul. 20, 2023

(54) ECONOMIES OF SCALE AWARE RESOURCE DISTRIBUTION

(71) Applicant: WANNASPLIT, INC., Wilmington, DE (US)

(72) Inventor: Justin Anthony Quinlan, Heywood Estates, St. Peter (BB)

(73) Assignee: WANNASPLIT, INC., Wilmington, DE (US)

(21) Appl. No.: 18/008,432

(22) PCT Filed: Jun. 3, 2021
(86) PCT No.: PCT/US21/35788

§ 371 Date: Dec. 5, 2022

Related U.S. Application Data
(60) Provisional application No. 63/034,376, filed on Jun. 3, 2020.

(51) Int. Cl. G06Q 30/0283

(52) U.S. Cl. CPC G06Q 30/0283

(57) ABSTRACT

Disclosed is a system that facilitates collaboration between partners to take advantage of economies of scale in the form of dynamic price differential between a first price for a resource when the resource is acquired at a point of sale. The point of sale is at a tagged location on a map accessible to at least one of the partners. The partners can communicate with one another in a virtual room created in association with the tagged location. The communication can include adjusting dynamic price differential allocations. At least one of the partners goes to the point of sale to complete resource distribution. A method of accomplishing resource distribution in this manner is also disclosed.

### BRIEF DESCRIPTION OF THE DRAWINGS

FIG. 1 is a diagram of an example of a system for economies of scale aware resource distribution.

FIG. 2 is a diagram of an example of a potential resource identification system.

FIG. 3 is a diagram of an example of a resource-to-profile allocation system.

FIG. 4 is a diagram of an example of an economies of scale system.

FIG. 5 is a diagram of an example of a resource-to-persona matching system.

FIG. 6 is a diagram of an example of a resource distribution system.

FIG. 7 is a flowchart of an example of economies of scale aware resource distribution.

FIG. 8 is a screen shot of a map with an open card.

FIG. 9 is two screen shots of a split creation window before and after data associated with the split has been entered.

FIG. 10 is a screen shot of a notification screen that includes requests to split.

FIG. 11 is a screen shot of a splash screen that follows joining a split.

FIG. 12 is a screen shot of a splash screen that follows joining a split, including virtual room interaction.

FIG. 13 is a flowchart of an example of shared dynamic pricing for a resource distributed at a point of sale.

### DETAILED DESCRIPTION

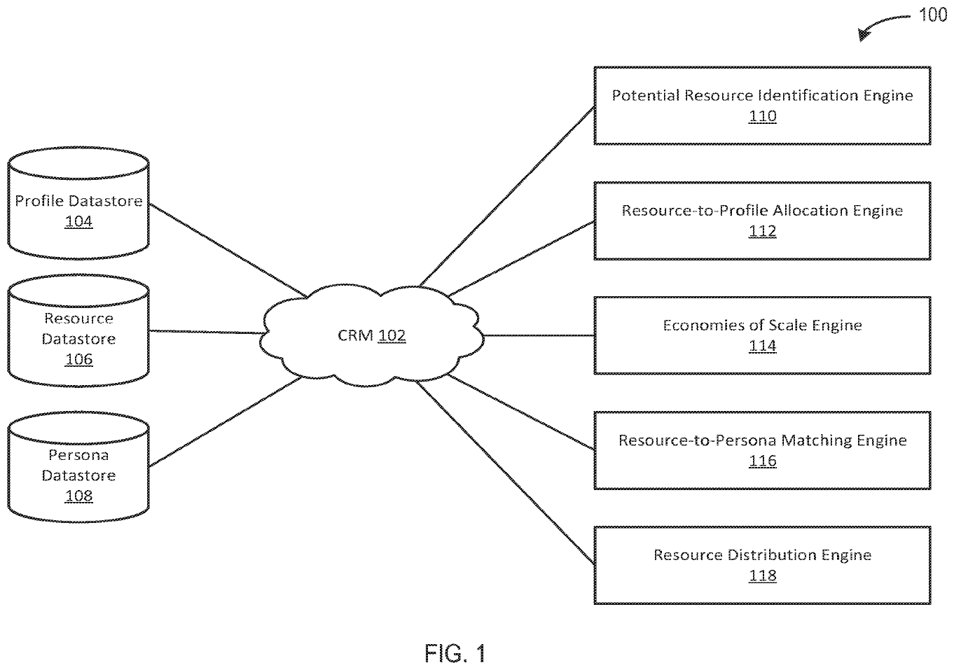

FIG. 1 is a diagram 100 of an example of a system for event management. The diagram 100 includes a computer-readable medium (CRM) 102, a profile datastore 104 coupled to the CRM 102, a resource datastore 106 coupled to the CRM 102, a persona datastore 108 coupled to the CRM 102, a potential resource identification engine 110 coupled to the CRM 102, a resource-to-profile allocation engine 112 coupled to the CRM 102, an economies of scale computation engine 114 coupled to the CRM 102, a resource-to-persona matching engine 116 coupled to the CRM 102, and a resource distribution engine 118 coupled to the CRM 102.

The CRM 102 in intended to represent a computer system or network of computer systems. A “computer system,” as used herein, may include or be implemented as a specific purpose computer system for carrying out the functionalities described in this paper. In general, a computer system will include a processor, memory, non-volatile storage, and an interface. A typical computer system will usually include at least a processor, memory, and a device (e.g., a bus) coupling the memory to the processor. The processor can be, for example, a general-purpose central processing unit (CPU), such as a microprocessor, or a special-purpose processor, such as a microcontroller.

Memory of a computer system includes, by way of example but not limitation, random access memory (RAM), such as dynamic RAM (DRAM) and static RAM (SRAM). The memory can be local, remote, or distributed. Non-volatile storage is often a magnetic floppy or hard disk, a magnetic-optical disk, an optical disk, a read-only memory (ROM), such as a CD-ROM, EPROM, or EEPROM, a magnetic or optical card, or another form of storage for large amounts of data. During execution of software, some of this data is often written, by a direct memory access process, into memory by way of a bus coupled to non-volatile storage. Non-volatile storage can be local, remote, or distributed, but is optional because systems can be created with all applicable data available in memory.

Software in a computer system is typically stored in non-volatile storage. Indeed, for large programs, it may not even be possible to store the entire program in memory. For software to run, if necessary, it is moved to a computer-readable location appropriate for processing, and for illustrative purposes in this paper, that location is referred to as memory. Even when software is moved to memory for execution, a processor will typically make use of hardware registers to store values associated with the software, and a local cache that, ideally, serves to speed up execution. As used herein, a software program is assumed to be stored at an applicable known or convenient location (from non-volatile storage to hardware registers) when the software program is referred to as “implemented in a computer-readable storage medium.” A processor is considered “configured to execute a program” when at least one value associated with the program is stored in a register readable by the processor.

In one example of operation, a computer system can be controlled by operating system software, which is a software program that includes a file management system, such as a disk operating system. One example of operating system software with associated file management system software is the family of operating systems known as Windows from Microsoft Corporation of Redmond, Wash., and their associated file management systems. Another example of operating system software with its associated file management system software is the Linux operating system and its associated file management system. The file management system is typically stored in the non-volatile storage and causes the processor to execute the various acts required by the operating system to input and output data and to store data in the memory, including storing files on the non-volatile storage.

The bus of a computer system can couple a processor to an interface. Interfaces facilitate the coupling of devices and computer systems. Interfaces can be for input and/or output (I/O) devices, modems, or networks. I/O devices can include, by way of example but not limitation, a keyboard, a mouse or other pointing device, disk drives, printers, a scanner, and other I/O devices, including a display device. Display devices can include, by way of example but not limitation, a cathode ray tube (CRT), liquid crystal display (LCD), or some other applicable known or convenient display device. Modems can include, by way of example but not limitation, an analog modem, an IDSN modem, a cable modem, and other modems. Network interfaces can include, by way of example but not limitation, a token ring interface, a satellite transmission interface (e.g. “direct PC”), or other network interface for coupling a first computer system to a second computer system. An interface can be considered part of a device or computer system.

Computer systems can be compatible with or implemented as part of or through a cloud-based computing system. As used in this paper, a cloud-based computing system is a system that provides virtualized computing resources, software and/or information to client devices. The computing resources, software and/or information can be virtualized by maintaining centralized services and resources that the edge devices can access over a communication interface, such as a network. “Cloud” may be a marketing term and for the purposes of this paper can include any of the networks described herein. The cloud-based computing system can involve a subscription for services or use a utility pricing model. Users can access the protocols of the cloud-based computing system through a web browser or other container application located on their client device.

A computer system can be implemented as an engine, as part of an engine, or through multiple engines. As used in this paper, an engine includes at least two components: 1) a dedicated or shared processor or a portion thereof; 2) hardware, firmware, and/or software modules executed by the processor. A portion of one or more processors can include some portion of hardware less than all of the hardware comprising any given one or more processors, such as a subset of registers, the portion of the processor dedicated to one or more threads of a multi-threaded processor, a time slice during which the processor is wholly or partially dedicated to carrying out part of the engine's functionality, or the like. As such, a first engine and a second engine can have one or more dedicated processors, or a first engine and a second engine can share one or more processors with one another or other engines. Depending upon implementation-specific or other considerations, an engine can be centralized, or its functionality distributed. An engine can include hardware, firmware, or software embodied in a computer-readable medium for execution by the processor. The processor transforms data into new data using implemented data structures and methods, such as is described with reference to the figures in this paper.

The engines described in this paper, or the engines through which the systems and devices described in this paper can be implemented, can be cloud-based engines. As used in this paper, a cloud-based engine is an engine that can run applications and/or functionalities using a cloud-based computing system. All or portions of the applications and/or functionalities can be distributed across multiple computing devices and need not be restricted to only one computing device. In some embodiments, the cloud-based engines can execute functionalities and/or modules that end users access through a web browser or container application without having the functionalities and/or modules installed locally on the end-users' computing devices.

As used in this paper, datastores are intended to include repositories having any applicable organization of data, including tables, comma-separated values (CSV) files, traditional databases (e.g., SQL), or other applicable known or convenient organizational formats. Datastores can be implemented, for example, as software embodied in a physical computer-readable medium on a general- or specific-purpose machine, in firmware, in hardware, in a combination thereof, or in an applicable known or convenient device or system. Datastore-associated components, such as database interfaces, can be considered “part of” a datastore, part of some other system component, or a combination thereof, though the physical location and other characteristics of datastore-associated components is not critical for an understanding of the techniques described in this paper.

Datastores can include data structures. As used in this paper, a data structure is associated with a way of storing and organizing data in a computer so that it can be used efficiently within a given context. Data structures are generally based on the ability of a computer to fetch and store data at any place in its memory, specified by an address, a bit string that can be itself stored in memory and manipulated by the program. Thus, some data structures are based on computing the addresses of data items with arithmetic operations; while other data structures are based on storing addresses of data items within the structure itself. Many data structures use both principles, sometimes combined in non-trivial ways. The implementation of a data structure usually entails writing a set of procedures that create and manipulate instances of that structure. The datastores, described in this paper, can be cloud-based datastores. A cloud based datastore is a datastore that is compatible with cloud-based computing systems and engines.

Assuming a CRM includes a network, the network can be an applicable communications network, such as the Internet or an infrastructure network. The term “Internet” as used in this paper refers to a network of networks that use certain protocols, such as the TCP/IP protocol, and possibly other protocols, such as the hypertext transfer protocol (HTTP) for hypertext markup language (HTML) documents that make up the World Wide Web (“the web”). More generally, a network can include, for example, a wide area network (WAN), metropolitan area network (MAN), campus area network (CAN), or local area network (LAN), but the network could at least theoretically be of an applicable size or characterized in some other fashion (e.g., personal area network (PAN) or home area network (HAN), to name a couple of alternatives). Networks can include enterprise private networks and virtual private networks (collectively, private networks). As the name suggests, private networks are under the control of a single entity. Private networks can include a head office and optional regional offices (collectively, offices). Many offices enable remote users to connect to the private network offices via some other network, such as the Internet.

Referring once again to the example of FIG. 1, the profile datastore 104 is intended to represent a datastore of demographic, psychographic, geographic, and/or behavioristic characteristics of a human or a human or artificial agent of an human, artificial, or legal entity. The profile datastore 104 can include representations what may be referred in various alternatives as users, members, subscribers, et al. For convenience, all such alternatives are referred to hereinafter as members but it should be understood, the “members” could be passive members, such as contacts or friends of an active member, those who provide information about themselves on a social media site, or the like.

The resource datastore 106 is intended to represent resources having characteristics attributable one or more demographic, geographic, psychographic, or behavioristic characteristics of a member. For example, a resource object may be attributable based upon geographic location relative to a member. Resources can include products or services available on the market. Instead or in addition, resources can include products or services already purchased or owned by a member.

The persona datastore 108 is intended to represent a datastore of member types. Each persona can have a set of characteristics with either a value or range of values for each characteristic.

The potential resource identification engine 110 is intended to represent an engine that creates, reads, updates, or deletes (CRUDs) the resource datastore 106 to include parameters associated with resources as they become available or unavailable. In a specific implementation, the potential resource identification engine 110 uses resource parameters in the resource datastore 106 and persona parameters in the persona datastore 108 to match potential resources to members represented in the profile datastore 104.

The resource-to-profile allocation engine 112 is intended to represent an engine that CRUDs the profile datastore 104 to link a member to a target resource. For example, a potential resource can become a target resource (linked to a member) by determining proximity of a member to a resource distribution location by utilizing geographic characteristics of the member from the profile datastore 104 to geographic characteristics of the resource from the resource datastore 106. In a specific implementation, the resource-to-profile allocation engine 112 is supplemented (or, alternatively, replaced) with a resource-to-persona allocation engine (not shown). In such an implementation, a member has one or more associated personas represented in the persona datastore 108 (due to one or more profile characteristics matching or falling within a range of at least a subset of persona characteristics for the one or more associated personas), any one of which can be matched to resources.

The economies of scale computation engine 114 is intended to represent an engine that computes economies of scale advantages for matching a target resource in the resource datastore 106 with other members represented in the profile datastore 104. In a specific implementation, a member can explicitly designate a resource as a target resource and designate a resource as having economies of scale advantages, such as if a member notices a store has a “two beverages for the price of one” sign on a window and decides sharing the cost of two half-priced beverages (an economy of scale) may be deemed beneficial to everyone involved. Economies of scale can also be applied to carpooling, resources that can be shared (e.g., software), or the like.

The resource-to-persona matching engine 116 is intended to represent an engine that matches a target resource to multiple members. In a specific implementation, the resource-to-persona matching engine 116 notifies members represented in the profile datastore 104 having at least one persona from the persona datastore 106 that match characteristics of a resource in the resource datastore 106. The resource can be member-identified (e.g., spotted while walking down the street), discovered through automated searches (e.g., utilizing bots to analyze websites that offer resources), submitted by resource providers who wish to be a part of the sharing economy, or the like.

The resource distribution engine 118 is intended to represent an engine that determines when the resource has been shared and how to manage expenses. For example, the resource distribution engine 118 can receive a notification that a first member represented in the profile datastore 104 has shared a resource in the resource datastore 106 with a second member represented int eh profile datastore 104 and made payment; the resource distribution engine 118 could then take payment from an account of the second member to and distribute the payment to an account of the first member. This is but one example of how expenses could be allocated, the simplest being both members pay their share at the point of sale.

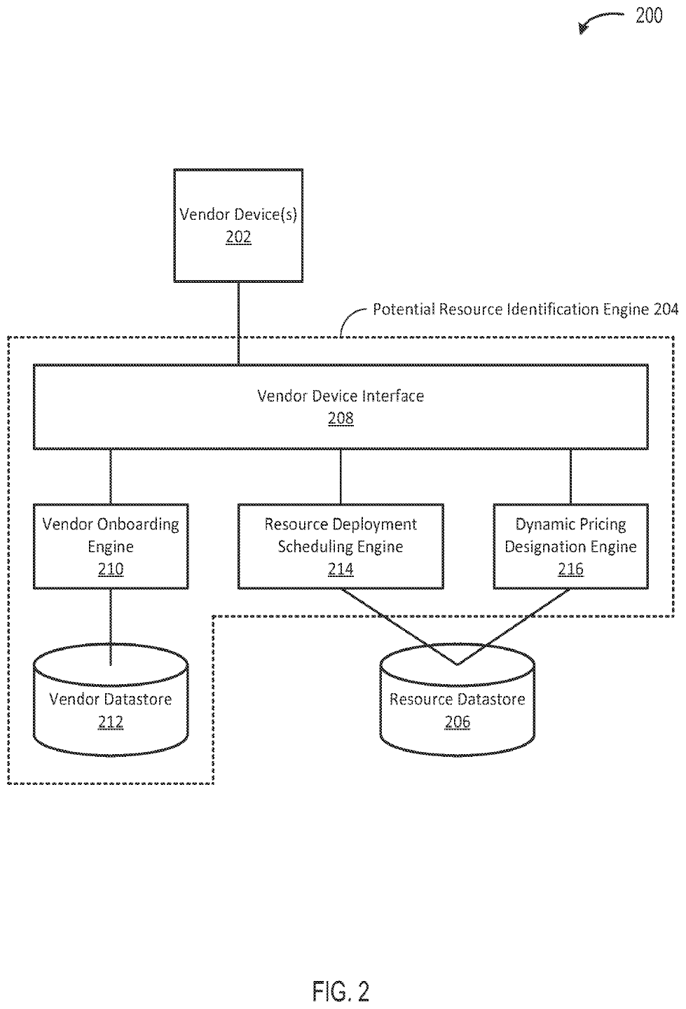

FIG. 2 is a diagram 200 of an example of a potential resource identification system. The diagram 200 includes vendor device(s) 202, a potential resource identification engine 204 coupled to the vendor device(s), and a resource datastore 206 coupled to the potential resource identification engine 204. In a specific implementation, the resource datastore 206 is the same as the resource datastore 106 of FIG. 1.

The vendor device(s) 202 are intended to represent one or more devices on which a vendor can access services of the potential resource identification engine 204 and, more generally, relevant parts of an economies of scale aware resource distribution system. In a specific implementation, the vendor device(s) 202 include a computer (or computing device) associated with a vendor and capable of accessing the potential resource identification engine 204 via a known or convenient communications technology, such as via a web browser and/or a radio transceiver. In an alternative, the vendor device(s) 202 includes a personal device of an individual who is authorized to act on behalf of a vendor. The vendor device(s) 202 can represent multiple devices that change over time (e.g., when a person utilizes web access first via a smartphone and then via a laptop or when multiple different human or artificial agents respectively use multiple different devices).

The potential resource identification engine 204 is intended to represent a potential resource identification engine as described above. See FIG. 1, the potential resource identification engine 110. In the example of FIG. 2, the potential resource identification engine 204 includes a vendor device interface 208 coupled to the vendor device(s) 202, a vendor onboarding engine 210 coupled to the vendor device interface 208, a vendor datastore 212 coupled to the vendor onboarding engine 210, a resource deployment scheduling engine 214 coupled to the vendor device interface 208, and a dynamic pricing designation engine 216 coupled to the vendor device interface 208. Engines in the potential resource identification engine 204 can be characterized as “subengines.”

The vendor device interface 208 is intended to represent hardware and software configured to facilitate access by the vendor device(s) 202 to services of the potential resource identification engine 204. For example, the vendor device interface can include a network interface, a password-protected web page, a node of a communication channel, or some other known or convenient technology. It may be noted that one or more of the vendor device(s) 202 may or may not be continuously coupled to the vendor device interface 208.

The vendor onboarding engine 210 is intended to represent an engine that obtains vendor data from the vendor device(s) 202. Vendor data can include coordinates or other data used to determine a location of resource outlets, such as retail or wholesale outlets. In a specific implementation, the vendor onboarding engine 210 also obtains vendor data from other sources via a human or artificial agent of the potential resource identification engine 204 or, more generally, an economies of scale aware resource distribution system. For example, the vendor onboarding engine 210 may or may not validate vendor-provided data, such as email or website. As another example, the vendor onboarding engine 210 may ask for verification of data through a separate communication channel with a vendor. These types of engines and the vendor onboarding engine 210, all of which store collected data or an identifier thereof in the vendor datastore 212, can be collectively referred to as a vendor datastore update engine.

The vendor datastore 212 is intended to represent a datastore of all data associated with a vendor that has been obtained by the vendor onboarding engine 210. In a specific implementation, the vendor datastore 212 is updated by human or artificial agents of an economies of scale aware resource distribution system when data associated with a vendor is acquired through other engines, including customer feedback, point of sale (POS) data, interest in offers (e.g., clicks), or the like.

The resource deployment scheduling engine 214 is intended to represent an engine that obtains resource parameters from the vendor device(s) 202 and updates the resource database 206 accordingly. The amount of detail included in resource parameters can vary depending upon implementation-, configuration-, and preference-specific parameters. For example, the potential resource identification engine 204 can operate with an honor system in which vendors provide little more than a resource identifier and a deployment schedule. As another example, the potential resource identification engine 204 could request much more information and validate the vendor, a brand, or other aspect of the vendor and/or resource. “Deployment” in this context is intended to indicate resources are in a position of readiness for use in a manner suitable for the system described in this paper. “Scheduling” in this context is intended to indicate deployment can be immediate or delayed until a future time and a resource would be considered unavailable (or not deployed) until the scheduled time unless otherwise updated. Depending on implementation-, configuration-, or preference-specific factors, the resource deployment scheduling engine 214 could be configured to allow immediate but not future deployments or to allow scheduled (future) but not immediate deployments, the latter of which become deployments in accordance with an associated schedule.

The dynamic pricing designation engine 216 is intended to represent an engine that obtains dynamic pricing parameters from the vendor device(s) 202 for resources. In a specific implementation, also obtains vendor data from other sources via a human or artificial agent of the potential resource identification engine 204 or, more generally, an economies of scale aware resource distribution system. For example, the potential resource identification engine 204 may include rules in a dynamic pricing rules datastore (not shown) that determine dynamic pricing from data found within the resource datastore 206. Instead or in addition, a dynamic pricing model can include an acceptable range, which enables a potential consumer to propose a price for a resource that can be accepted if it falls within the range or declined if it falls outside the range; this can include gamification. The dynamic pricing model can also fluctuate with time, such as a “happy hour” discount, a seasonal discount, or the like, or to offer improved rates for potential consumers of a particular persona or having a particular profile parameter.

The resource datastore 206 is intended to represent a resource datastore as described elsewhere in this paper. See, e.g., FIG. 1, the resource datastore 106. In the example of FIG. 2, the resource datastore 206 is updated by the resource deployment scheduling engine 214 to include parameters of resources that are or will be deployed and updated by the dynamic pricing designation engine 216 to include dynamic pricing parameters for the resources. In a specific implementation, the resource datastore 206 is updated by human or artificial agents of an economies of scale aware resource distribution system when data associated with a resource is acquired through other engines, including manual entry of data (e g , if a human agent of a vendor calls or meets in person, during which deployment and/or dynamic pricing is disclosed). These types of engines, the resource deployment scheduling engine 214, and the dynamic pricing designation engine 216 can be collectively referred to as a resource datastore update engine.

In an alternative, an economies of scale aware resource distribution system does not include any vendors (or, equivalently, includes only one vendor). In such an alternative, the vendor onboarding engine 210 is unnecessary and the vendor datastore 212 can be characterized as a business intelligence datastore for an enterprise.

In an example of operation, the vendor onboarding engine 210 receives vendor data from the vendor device(s) 202 via the vendor device interface 208 for storage in the vendor datastore 212. For example, for a vendor “ABC Corp.” (a clothing store in this example) the vendor datastore 212 may be updated to include the name of and contact information for ABC Corp., along with a username and password to enable login from a variety of different devices.

Continuing this example of operation, the resource deployment scheduling engine 214 receives resource parameter data from the vendor device(s) 202 via the vendor device interface 208 for storage in the resource datastore 206. For example, the resource datastore 206 may be updated to include currently available pairs of socks from ABC Corp.

Continuing this example of operation, the dynamic pricing designation engine 216 receives dynamic pricing parameter data from the vendor device(s) 202 via the vendor device interface 208 for storage in the resource datastore 206. For example, the resource datastore 206 may be updated to indicate pricing for a pair of socks, two pairs of socks, and/or some other number of pairs of socks, either explicitly by number or using a formula based on the number of pairs of socks purchased at a time.

Continuing this example of operation, the resource datastore 206 can be used by other engines of an economies of scale aware resource distribution system to allow a member to receive rewards in the form of the difference in dynamic pricing (or a portion thereof) if the member splits a purchase of two (or more) pairs of socks with other potential consumers.

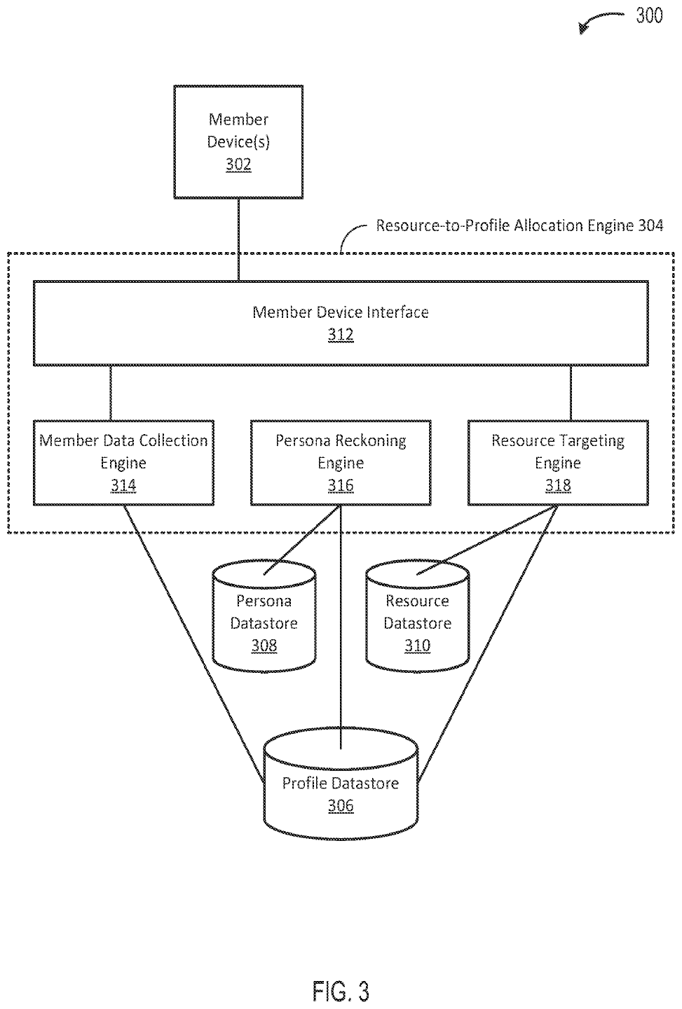

FIG. 3 is a diagram 300 of an example of a resource-to-profile allocation system. The diagram 300 includes member device(s) 302, a resource-to-profile allocation engine 304 coupled to the member device(s), a profile datastore 306 coupled to the resource-to-profile allocation engine 304, a persona datastore 308 coupled to the resource-to-profile allocation engine 304, and a resource datastore 310 coupled to the resource-to-profile allocation engine 304. In a specific implementation, the profile datastore 306 is the same as the profile datastore 104 of FIG. 1, the resource datastore 310 is the same as the resource datastore 106 of FIG. 1, and/or the persona datastore 308 is the same as the persona datastore 108 of FIG. 1.

The member device(s) 302 are intended to represent one or more devices on which a member can access services of the resource-to-profile allocation engine 304 and, more generally, relevant parts of an economies of scale aware resource distribution system. In this context, a member is a potential consumer of deployed resources. In a specific implementation, the member device(s) 302 include a computer (or computing device) associated with a member and capable of accessing the resource-to-profile allocation engine 304 via a known or convenient communications technology, such as via a web browser and/or a radio transceiver. In an alternative, the member device(s) 302 include a personal device of an individual who is authorized to act on behalf of a member. The member device(s) 302 can represent multiple devices that change over time (e.g., when a person utilizes web access first via a smartphone and then via a laptop or when multiple different human or artificial agents respectively use multiple different devices).

The resource-to-profile allocation engine 304 is intended to represent a resource-to-profile allocation engine as described above. See FIG. 1, the resource-to-profile allocation engine 112. In the example of FIG. 3, the resource-to-profile allocation engine 304 includes a member device interface 312 coupled to the member device(s) 302, a member data collection engine 314 coupled to the member device interface 312, a persona reckoning engine 316 coupled to the member device interface 312, and a resource targeting engine 318 coupled to the member device interface 312. Engines in the resource-to-profile allocation engine 304 can be characterized as “subengines.”

The member device interface 312 is intended to represent hardware and software configured to facilitate access by the member device(s) 302 to services of the resource-to-profile allocation engine 304. For example, the member device interface 312 can include a network interface, a password-protected web page, a node of a communication channel, or some other known or convenient technology. It may be noted that one or more of the member device(s) 302 may or may not be continuously coupled to the member device interface 312.

The member data collection engine 314 is intended to represent an engine that obtains member data from the member device(s) 302. Member data can include GPS data, appointment data, or other data used to estimate a location of one or more of the member device(s) 302 or a user thereof at a given time. In a specific implementation, the member data collection engine 314 also obtains member data from other sources via a human or artificial agent of the resource-to-profile allocation engine 304 or, more generally, an economies of scale aware resource distribution system. For example, the member data collection engine 314 may or may not validate member-provided data, such as email or credit card information. As another example, the member data collection engine 314 may ask for verification of data through a separate communication channel with a social network. These types of engines and the member data collection engine 314, all of which store collected data or an identifier thereof in the profile datastore 306, can be collectively referred to as a member datastore update engine.

The persona reckoning engine 316 is intended to represent an engine that matches a set of personas of the persona datastore 308 to a profile of the profile datastore 306. In a specific implementation, the persona reckoning engine 316 matches a plurality of personas to a profile of a member and incorporates an identifier of each of the personas in the profile datastore 306. In an alternative, no such explicit identification of personas is done. Indeed, in a specific implementation, resource-to-profile allocation can be accomplished without considering persona.

The resource targeting engine 318 is intended to represent an engine that matches a deployed resource to a member. In a specific implementation, the resource targeting engine 318 compares a parameter of a member represented in the profile datastore 306 to a parameter of a resource represented in the resource datastore 310 to determine whether the parameters match. In this context, a match can mean a member parameter is the same as, falls within a range of, exceeds a threshold value of, or is otherwise determined to match a resource parameter, or vice versa. For example, a resource can have a targeting range parameter and a member can have a location parameter; when the location of the member is within the targeting range of the resource, the member can be matched to the resource. For illustrative convenience, retained data associated with matching a resource to a member is maintained in the profile datastore 306 (and is assumed to be a part of profile datastores described with reference to other figures in this paper, if applicable for a given context).

In a specific implementation, the resource targeting engine 318 makes a notification of the match available to a member via the member device interface 312. For example, the resource targeting engine 318 may send a text message to an applicable one of the member device(s) 302, send an email that is ultimately accessed via one of the member device(s) 302, updates the profile datastore 306 to indicate the match such that a member can eventually see the match when accessing the profile datastore 306 via the member device interface 312, or takes some other known or convenient action that notifies a member that a match was made. The resource targeting engine 318 may or may not update the resource datastore 310 (or explicitly notify a vendor responsible for deploying a target resource) to enable a vendor to determine the number of times members were made aware of a target resource, to learn a parameter associated with targeted members, or gain some other statistic or analytic associated with their resources.

The profile datastore 306 is intended to represent a profile datastore as described elsewhere in this paper. See, e.g., FIG. 1, the profile datastore 104. In the example of FIG. 3, the member data collection engine 314 updates the profile datastore 306 when a member registers to become a member (e.g., during onboarding of a new member), when a member provides data about themselves to the member data collection engine (e.g., via quizzes), or when data associated with a member is otherwise obtained by the member data collection engine 314. In the example of FIG. 3, optionally, the profile datastore 306 is updated by the persona reckoning engine 316 when a persona is matched to a member profile and/or by the resource targeting engine 318 when a resource it matched to a member profile.

The persona datastore 308 is intended to represent a persona datastore as described elsewhere in this paper. See, e.g., FIG. 1, the persona datastore 108. In the example of FIG. 3, the persona datastore 308 is accessed by the persona reckoning engine 316 when attempting to match a persona to a member.

The resource datastore 310 is intended to represent a resource datastore as described elsewhere in this paper. See, e.g., FIG. 1, the resource datastore 106. In the example of FIG. 3, the resource datastore 310 is accessed by the resource targeting engine 318 when attempting to match a resource to a member.

In an example of operation, the member data collection engine 314 receives member data from the member device(s) 302 via the member device interface 312 for storage in the profile datastore 306. For example, during a member registration process, the profile datastore 306 may be updated to include the name of and contact information for the member, along with a username and password to enable login from a variety of different devices. Over time, the member data collection engine 314 can obtain additional data from the member device(s) 302, such as data from quizzes, GPS data, or the like, or additional data from other sources.

Continuing this example of operation, the persona reckoning engine 316 may or may not match a persona to a profile and update the profile datastore 306 accordingly. For example, the profile datastore 306 may be updated to identify a persona for which a profile is applicable. It may be noted that the persona need not be a human-readable persona, such as “18-49 years old”, but rather could represent a collection of parameters that have been determined via machine learning to be relevant to resource targeting for reasons that are not necessarily clear to a human.

Continuing this example of operation, the resource targeting engine 318 matches a resource to the profile of the member. Resource parameters can include geographic, psychographic, demographic, behavioristic, and other values (or ranges of values) that can be matched to a profile, such as current location, work address, interests, personality, annual income, age (of self or a dependent), social media posts, previous purchases, or the like. When a match is made, the resource targeting engine 318 makes the member aware by making a notification of the match available to an applicable one or more of the member device(s) 302 via the member device interface 312, such as by sending an instant message.

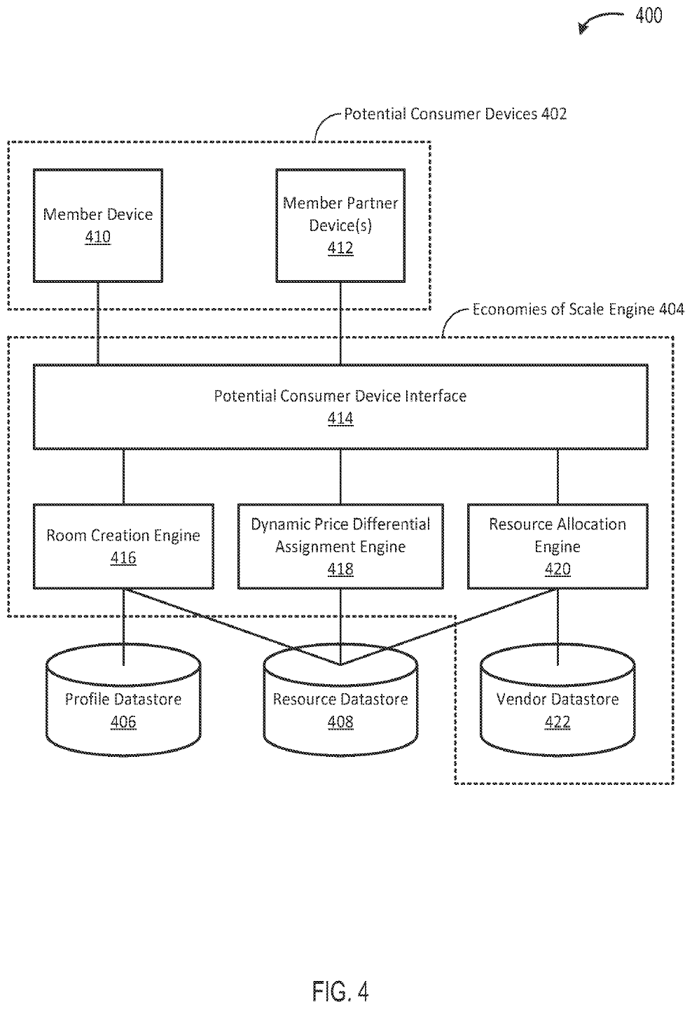

FIG. 4 is a diagram 400 of an example of an economies of scale system. The diagram 400 includes potential consumer devices 402, an economies of scale engine 404 coupled to the potential consumer devices 402, a profile datastore 406 coupled to the economies of scale engine 404, and a resource datastore 408 coupled to the economies of scale engine 404. In a specific implementation, the profile datastore 406 is the same as the profile datastore 104 of FIG. 1 and the resource datastore 408 is the same as the resource datastore 106 of FIG. 1.

The potential consumer devices 402 are intended to represent a plurality of devices on which a potential consumer can access services of the economies of scale engine 404 and, more generally, relevant parts of an economies of scale aware resource distribution system. The potential consumer devices 402 include a member device 410 and member partner device(s) 412. The member partner device(s) 412 may or may not include member devices (e.g., where the member device 410 is associated with a first member and one of the member partner device(s) 412 is associated with a second member). In an alternative, it may be a requirement of the economies of scale engine 404 that each of the member partner device(s) 412 is associated with a respective member; in such an alternative, potential consumers who are not members may be prompted to become members prior to participation through a registration process (see, e.g., description of the member data collection engine 314 of FIG. 3, above). In a specific implementation, the potential consumer devices 402 include a computer (or computing device) associated with a potential consumer of a resource represented in the resource datastore 408 and capable of accessing the economies of scale engine 404 via a known or convenient communications technology, such as via a web browser and/or a radio transceiver. In an alternative, the potential consumer devices 402 include a personal device of an individual who is authorized to act on behalf of a member or other potential consumer. For illustrative purposes, the potential consumer devices 402 represent multiple devices that are relevant to a single instance of allocation of a target resource.

The economies of scale engine 404 is intended to represent an economies of scale engine as described above. See FIG. 1, the economies of scale engine 114. In the example of FIG. 4, the economies of scale engine 404 includes a potential consumer device interface 414 coupled to the potential consumer devices 402, a room creation engine 416 coupled to the potential consumer device interface 414, a dynamic price differential assignment engine 416 coupled to the potential consumer device interface 414, a resource allocation engine 420 coupled to the potential consumer device interface 414, and a vendor datastore 422 coupled to the resource allocation engine 420. Engines in the economies of scale engine 404 can be characterized as “subengines.”

The potential consumer device interface 414 is intended to represent hardware and software configured to facilitate access by the potential consumer devices 402 to services of the economies of scale engine 404. For example, the potential consumer device interface 414 can include a network interface, a password-protected web page, a node of a communication channel, or some other known or convenient technology. It may be noted that one or more of the potential consumer devices 402 may or may not be continuously coupled to the potential consumer device interface 414.

The room creation engine 416 is intended to represent an engine that creates a virtual room for a member (associated with the member device 410 and represented in the profile datastore 406) matched to a target resource (represented in the resource datastore 408). In a specific implementation, the virtual room is created when the member responds affirmatively to a notification of the match. The room creation engine 416 updates the profile datastore 406 and/or the resource datastore 408 with room creation parameters, such as an identifier of the room created for the member, acceptance of the match notification, fees paid to utilize the room, etc. (If applicable, the update can be characterized as a log file of events associated with creation of the virtual room.) Characteristics and use of the virtual room are described in more detail below.

The dynamic price differential assignment engine 418 is intended to represent an engine that facilitates the assignment of savings (from the perspective of a consumer) associated with dynamic pricing price differentials. In a specific implementation, a dynamic pricing model is provided by a vendor (see, e.g., dynamic pricing designation engine 216 of FIG. 2), which may or may not be responsive to a counteroffer from a potential consumer. Potential consumers can discuss dynamic pricing differential assignment relative to one another in the virtual room, invite additional potential consumers to improve economies of scale, or take other actions that impact dynamic price and/or dynamic price differential assignment. The dynamic price differential assignment engine 418 updates the resource datastore 408 in accordance with dynamic pricing adjustments and assignments. If one or more member partners are also members, the profile datastore 406 can also be updated (link connecting dynamic price differential assignment engine 418 and profile datastore 406 not shown). Characteristics and use of the virtual room are described in more detail below.

The resource allocation engine 420 is intended to represent an engine that updates the vendor datastore 422 regarding revenue generation attributed to the economies of scale engine 404. In a specific implementation, the resource allocation engine 420 updates the vendor datastore 422 to identify conversion of potential consumers to actual consumers. Depending upon implementation-, configuration-, and preference-specific factors, the identification of the consumers may include a mailing address to which an instance of the relevant resource can be shipped, though member partners can also maintain anonymity, if applicable (e.g., when instances of the resource are distributed at point of sale, provided to the member for distribution to member partners, or the like). Indeed, even in an implementation in which potential consumers must be members, anonymity may be maintained vis-à-vis the vendor, if applicable.

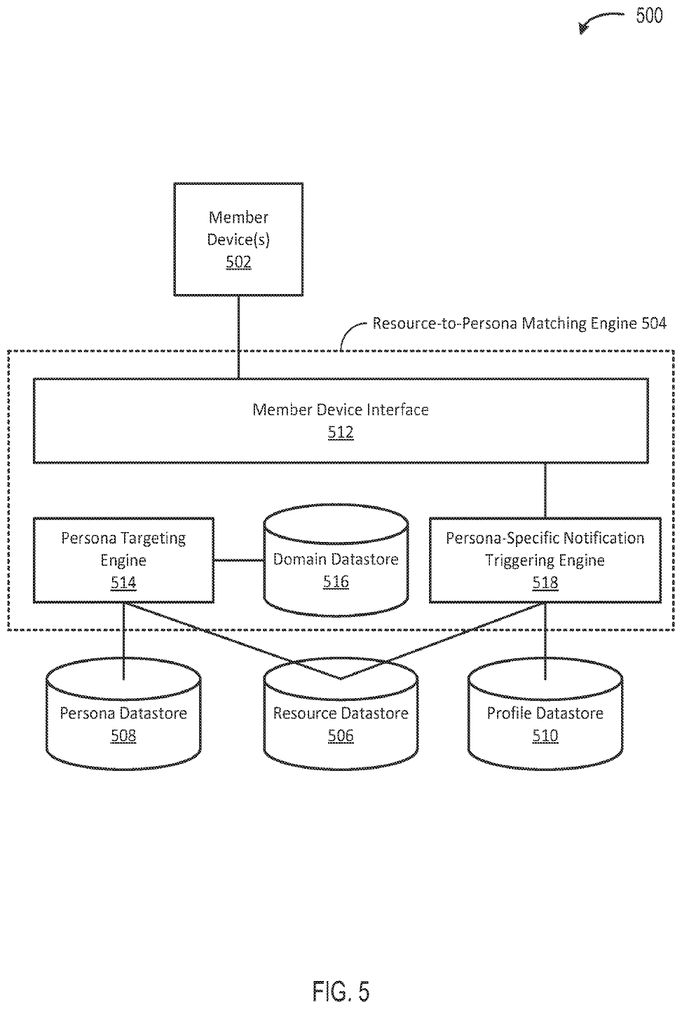

FIG. 5 is a diagram 500 of an example of a resource-to-persona matching system. The diagram 500 includes member device(s) 502, a resource-to-persona allocation engine 504 coupled to the member device(s) 502, a resource datastore 506 coupled to the resource-to-persona matching engine 504, a persona datastore 508 coupled to the resource-to-persona matching engine 504, and a profile datastore 510 coupled to the resource-to-persona matching engine 504. In a specific implementation, the profile datastore 510 is the same as the profile datastore 104 of FIG. 1, the resource datastore 506 is the same as the resource datastore 106 of FIG. 1, and/or the persona datastore 508 is the same as the persona datastore 108 of FIG. 1.

The member device(s) 502 are intended to represent one or more devices on which a member can access services of the resource-to-persona matching engine 504 and, more generally, relevant parts of an economies of scale aware resource distribution system. In this context, a member is a potential consumer of deployed resources. In a specific implementation, the member device(s) 502 include a computer (or computing device) associated with a member and capable of accessing the resource-to-persona matching engine 504 via a known or convenient communications technology, such as via a web browser and/or a radio transceiver. In an alternative, the member device(s) 502 include a personal device of an individual who is authorized to act on behalf of a member. The member device(s) 502 can represent multiple devices that change over time (e.g., when a person utilizes web access first via a smartphone and then via a laptop or when multiple different human or artificial agents respectively use multiple different devices).

The resource-to-persona matching engine 504 is intended to represent a resource-to-persona matching engine as described above. See FIG. 1, the resource-to-persona matching engine 112. In the example of FIG. 5, the resource-to-persona matching engine 504 includes a member device interface 512 coupled to the member device(s) 502, a persona targeting engine 514, a domain knowledge datastore 516 coupled to the persona targeting engine 514, and a persona-specific notification triggering engine 518 coupled to the member device interface 512. Engines in the resource-to-persona matching engine 504 can be characterized as “subengines.”

The member device interface 512 is intended to represent hardware and software configured to facilitate access by the member device(s) 502 to services of the resource-to-persona matching engine 504. For example, the member device interface 512 can include a network interface, a password-protected web page, a node of a communication channel, or some other known or convenient technology. It may be noted that one or more of the member device(s) 502 may or may not be continuously coupled to the member device interface 512.

The persona targeting engine 514 is intended to represent an engine that identifies a resource appropriate for a persona. In a specific implementation, a vendor may indicate appropriate personas for a resource during resource deployment (see, e.g., FIG. 2). For illustrative convenience, data collected in this manner can be considered to reside in the domain knowledge datastore 516. (Note: In the example of FIG. 2, a domain knowledge datastore is not shown, but can be considered part of the resource datastore 206 because it is an explicit parameter.) Instead or in addition, the persona targeting engine 514 can determine a resource is appropriate for a persona using the domain knowledge datastore 516. Domain knowledge can be generated by recognizing a resource is more desirable to members of a first persona and indicating a resource is appropriate for the first persona; new personas can also be generated (updating the persona datastore 508 is not shown) by recognizing a resource is more desirable to members with a first profile parameter value. The persona targeting engine 514 updates the resource datastore 506 to identify a persona in the persona datastore 508 to which a resource can be targeted with a probability of success greater than random targeting (a “relevant persona”). This can also be provided as analytics feedback to vendors, if applicable.

The persona-specific notification triggering engine 518 is intended to represent an engine that generates a notification for a member who has a relevant persona. In a specific implementation, when a member has a parameter in the profile datastore 510 that is within a range or exceeds a threshold, the persona-specific notification triggering engine 518 determines whether the member has a relevant persona and, if so, generates a notification for the member that is obtained at one of the member device(s) 502 via the member device interface 512. For example, if the profile datastore 510 indicates a member device of the member device(s) 502 is within a mile (e.g., because the profile datastore 510 is updated with GPS data) of a toy store that includes a resource (a baby toy for the purpose of this example) represented in the resource datastore 506 and the profile datastore 510 indicates the member has a persona for which a baby toy would be desirable (a female between the age of 18 and 49 for the purpose of this example), the persona-specific notification triggering engine 518 could be configured to generate a notification for the member.

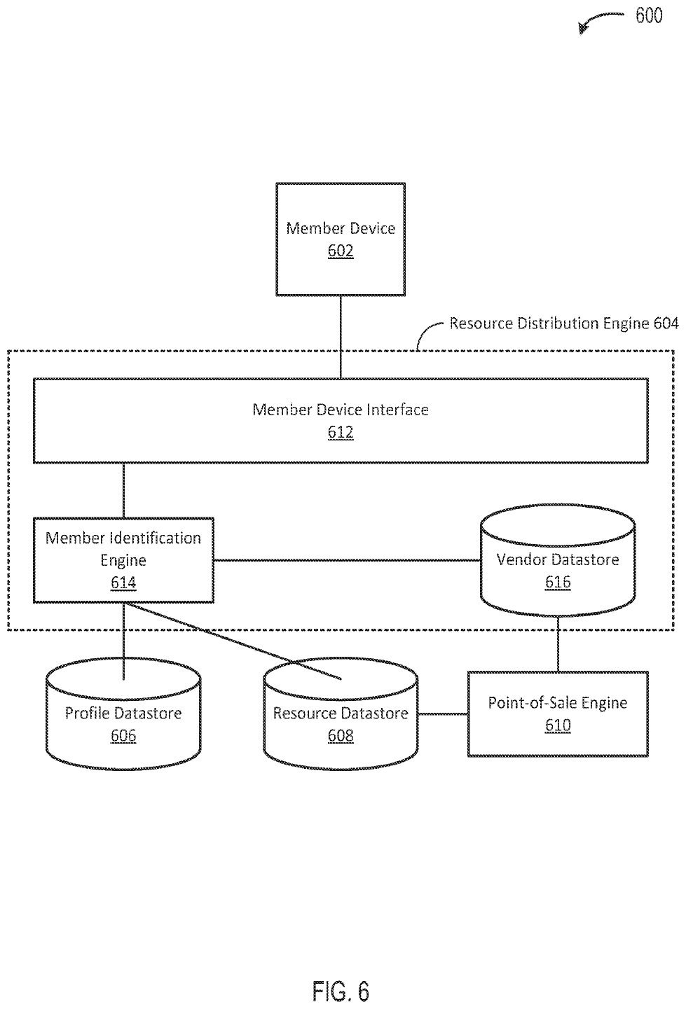

FIG. 6 is a diagram 600 of an example of a resource distribution system. The diagram 600 includes a member device 602, a resource distribution engine 604 coupled to the member device 602, a profile datastore 606 coupled to the resource distribution engine 604, a resource datastore 608 coupled to the resource distribution engine 604, and a point-of-sale (Pos) engine 610 coupled to the resource distribution engine 604. In a specific implementation, the profile datastore 606 is the same as the profile datastore 104 of FIG. 1 and the resource datastore 608 is the same as the resource datastore 106 of FIG. 1.

The member device 602 is intended to represent a device on which a member can access services of the resource distribution engine 604 and, more generally, relevant parts of an economies of scale aware resource distribution system. In a specific implementation, the member device 602 includes a computer (or computing device) associated with a member represented in the profile datastore 606 to whom a resource represented in the resource datastore 608 is distributed and capable of accessing the resource distribution engine 604 via a known or convenient communications technology, such as via a web browser and/or a radio transceiver. In an alternative, the member device 602 includes a personal device of an individual who is authorized to act on behalf of a member. For illustrative purposes, the member device 602 represents a device that is relevant to a single instance of distribution of a target resource.

The resource distribution engine 604 is intended to represent a resource distribution engine as described above. See FIG. 1, the resource distribution engine 114. In the example of FIG. 6, the resource distribution engine 604 includes a member device interface 612 coupled to the member device 602, a member identification engine 614 coupled to the member device interface 612, and a vendor datastore 616 coupled to the member identification engine 614. Engines in the resource distribution engine 604 can be characterized as “subengines.”

The member device interface 612 is intended to represent hardware and software configured to facilitate access by the member device 602 to services of the resource distribution engine 604. For example, the member device interface 612 can include a network interface, a password-protected web page, a node of a communication channel, or some other known or convenient technology.

The member identification engine 614 is intended to represent an engine that indicates the member device is that of a member represented in the profile datastore 606 to whom a resource represented in the resource datastore 608 is to be distributed. The member identification engine 614 updates the vendor datastore 616 to identify the member.

The vendor datastore 616 is intended to represent a datastore that includes data associated with the transaction. The vendor datastore 616 may or may not include information about member partners. The manner in which dynamic pricing differentials are allocated is described below.

The PoS engine 610 is intended to represent hardware and software at an outlet of a resource. In a specific implementation, the PoS engine 610 accesses information from the vendor datastore 616 and the resource datastore 608 regarding parameters of the transaction. Instead or in addition, the PoS engine 610 can obtain data directly from the member device 602, such as by scanning a QR code on a display of the member device 602 to indicate dynamic pricing is applicable. In an alternative, the PoS engine 610 does not access the resource datastore 608 and/or the vendor datastore 616 and processes the transaction as any other; a member may receive a rebate or other remuneration following the transaction from a party other than that of the PoS.

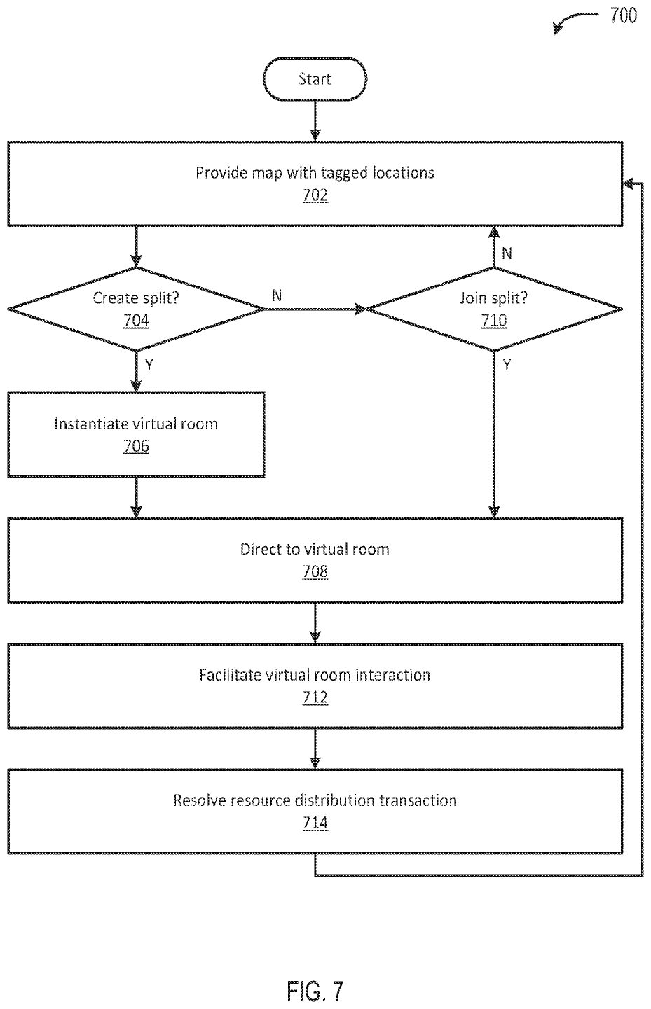

FIG. 7 is a flowchart 700 of an example of economies of scale aware resource distribution. In the example of FIG. 7, the flowchart 700 starts at module 702 with providing a map with tagged locations. As used in this paper, a tagged location is a resource outlet. In a specific implementation, a potential consumer receives the map and can click on a tagged location to obtain information about a resource at a tagged location.

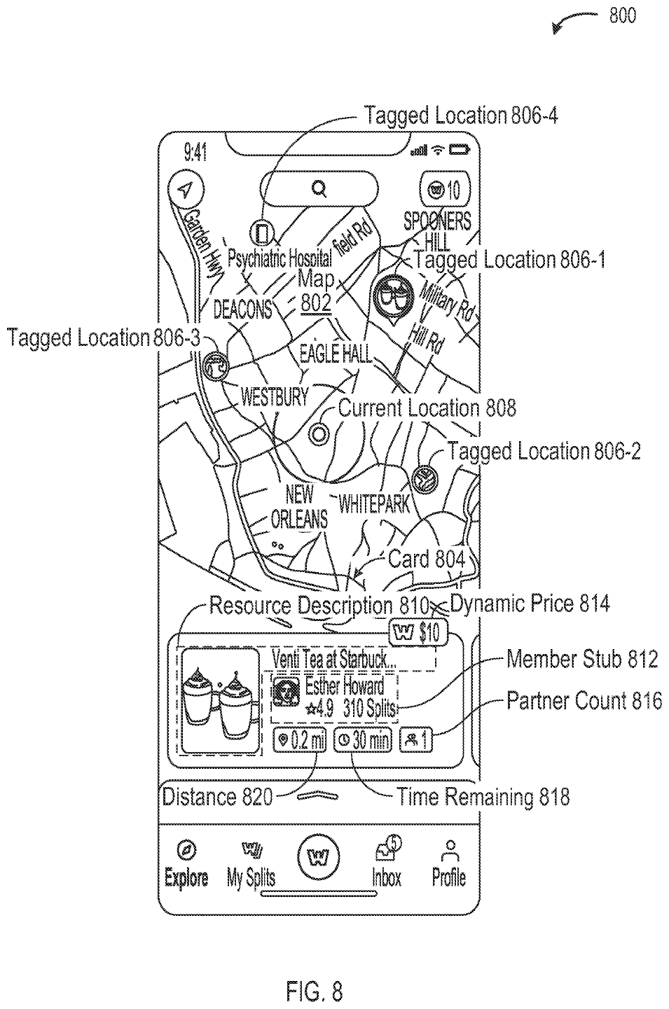

FIG. 8 is a screen shot 800 of a map with an open card. The screen shot 800 illustrates by way of example a specific implementation of an aspect of an economies of scale aware resource distribution system. Among other things, the screenshot 800 includes a map 802 and a card 804.

The map 802 includes a tagged location 806-1 to a tagged location 806-4 (collectively, the tagged locations 806) and a current location indication 808. Because the map 802 includes the tagged locations 806, it represents one example of a “map with tagged locations.” The current location indication 808 is a representation of an estimate of the location of a device displaying the map 802. In an implementation that recognizes future location (e.g., as obtained from calendar entries), a future location may or may not, instead or in addition, be displayed on the map. Also, if the map 802 is displayed on a device other than that of the individual who may take advantage of a dynamic price (“potential partner”), the current location 808 could represent the potential partner's current location, rather than the current location of the device on which the map 802 is displayed.

The card 804 includes a resource description 810, member stub 812, a dynamic price indication 814, a partner count indication 816, a time remaining indication 818, and a distance indication 820. In this example, the tagged location 806-1 has been selected, which causes data associated with the tagged location 806-1 to be presented in the card 804. In a specific implementation, clicking on the card 804 directs a potential partner to a page at which the potential partner can take advantage of the dynamic price of the relevant resource.

The resource description 810 includes an image and brief description of a resource at the tagged location 806-1. Depending upon implementation-, configuration-, or preference-specific factors, hovering over the resource description 810 may show more information (e.g., any portion of the resource description 810 that does not fit inside the allotted space) and/or clicking on the resource description 810 may or may not provide more detailed information.

The member stub 812 includes a picture, name, rating, and split history of the member who is making the offer to take advantage of dynamic pricing for a resource (the “founding member”). In a specific implementation, the split history is the number of times the member acted as a founding member or partner and the relevant resource was subsequently distributed. In an alternative, split history could instead or in addition indicate how many times the member acted as a founding member, how many times the member acted as a partner, how many times the member acted as a founding member and the resource was subsequently distributed, how many times the member acted as a partner and the resource was subsequently distributed, and/or how many times the member acted as a partner but was a no-show (though the latter can also probably be indirectly construed from a rating).

The dynamic price 814 indicates a current dynamic price, $10 in this example, for the resource described in the resource description 810, venti tea in this example. In a specific implementation, the dynamic price decreases as partners join. For example, if a partner joins the offer of this example, the dynamic price 814 can be divided between the member and the partner, causing the dynamic price to decrease to $5 instead of $10. In an alternative, the dynamic price could display only the share of the price for which a partner would be responsible. For example, a member is responsible for the full $10 of this example if they wish to take advantage of dynamic pricing to acquire two venti teas, but the card of a potential partner would indicate a dynamic price of $5 (the price of one venti tea) and this would be true even if the dynamic price was $15 for three venti teas (not shown). The dynamic price can also decrease in accordance with agreements made in a virtual room associated with the resource, though this may or may not be represented in the dynamic price 814.

The partner count 816 indicates how many partners have joined the offer, inclusive of the member who made the offer. In this example the card 804 represents an offer for which no partners (other than the founding member) have joined. Accordingly, the indicated partner count is 1.

The time remaining 818 indicates the amount of time remaining to accept the offer. In a specific implementation, the founding member sets a time for response. In a specific implementation, the time remaining 818 also represents when partners are expected to be at the tagged location. In an alternative, the time remaining 818 could be replaced with a time window (e.g., 8:00 to 8:15), an amount of time before the offer closes, or some other metric that is deemed appropriate, depending upon implementation-, configuration-, or preference-specific factors.

The distance 820 indicates the distance between the current location 808 and the tagged location 806-1 (in this example). In a specific implementation, the distance 820 indicates an as-the-bird-flies distance, but in alternatives, the distance 820 can be replaced with a walking distance, a driving distance, an estimated time to reach the destination (when walking or driving), or some other metric that is deemed appropriate, depending upon implementation-, configuration-, or preference-specific factors.

Referring once again to the example of FIG. 7, the flowchart 700 continues to decision point 704 where it is determined whether a member creates a split. In a specific implementation, only members can actually create a split, though a non-member may have access to the map with tagged locations and have the opportunity to create a split by first becoming a member. In a specific implementation, only tagged locations have resources that are splitable. However, dynamic pricing offers may be publicly available (e.g., as a two for the price of one coupon) for a location that is not a tagged location; in an alternative, a member can create a split for a dynamic pricing offer and dynamically tag a location at which the dynamic pricing offer can be accepted. The dynamically tagged locations can be treated equivalently to other tagged locations (with participating vendors) with the understanding that some details of the resource distribution may be more difficult to track.

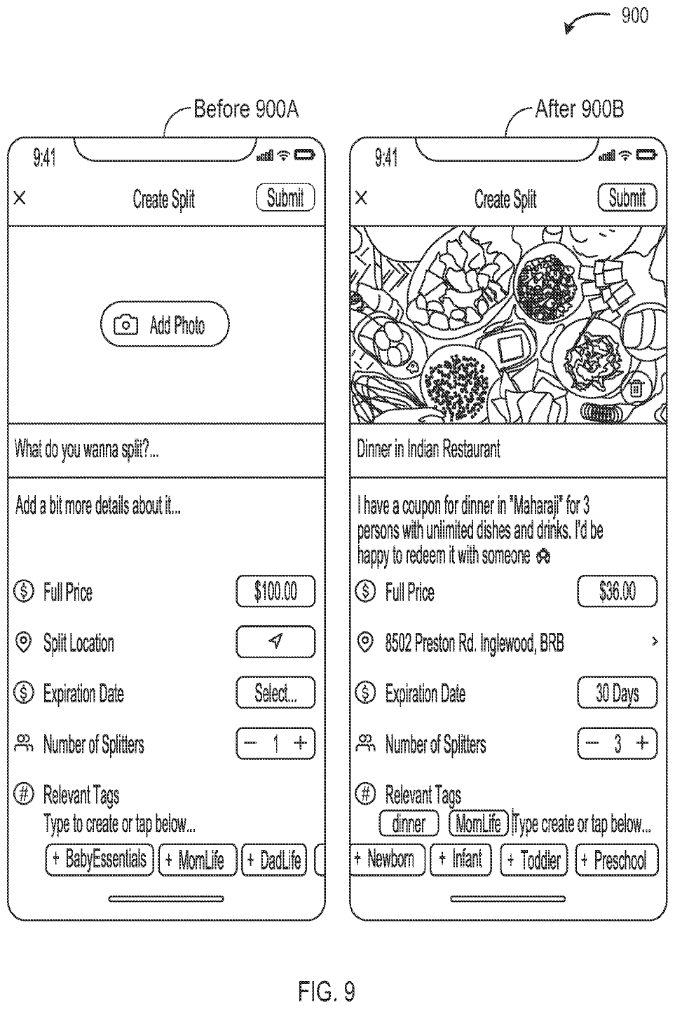

FIG. 9 is two screen shots 900 of a split creation window before (900A) and after data associated with the split has been entered (900B). The screen shots 900 illustrate by way of example a specific implementation of an aspect of an economies of scale aware resource distribution system. Among other things, the screenshots 900 include details that are depicted in the example of FIG. 8 (e.g., resource description, full (dynamic) price, location, and time remaining (expiration date)). Additional data includes number of splitters, which is a maximum number of partners for which the dynamic pricing is applicable and relevant tags, which is useful for matching to the interests of a potential partner. In an alternative, the number of splitters can be a range (e.g., if there is a further discount for more partners or if there is room for more partners at the dynamic price the minimum number of splitters and maximum number of splitters could be different). Also, depending upon how much involvement there is on the part of a vendor, suggestions and offers can be provided.

Referring once again to the example of FIG. 7, if it is determined the member (or potential partner) creates a split (704-Y), then the flowchart 700 continues to module 706 where a virtual room is instantiated and to module 708 where the member is directed to the virtual room. In a specific implementation, instantiating a virtual room has an associated cost (which is referred to in the abstract as a coin in this paper); in a specific implementation, the member can be characterized as paying a coin to create a split. In an alternative, a vendor may pay the coin to instantiate a room instead of the member. Instead or in addition, the member can receive a reward (e.g., a coin) if a partner joins (or a plurality of partners join) the virtual room.

In a specific implementation, the member is prompted to invite potential partners to the split, which can be obtained from contacts, followers, or a nearby second member who has consented to notification. The amount of information a founding member has about a second member depends upon implementation-, configuration-, or preference-specific parameters. In an implementation in which a second member is notified, the second member may have indicated interests, so matching of tags is possible, the second member's location may be known, though it is unlikely such information would be shared with a first member unless the desire to share such information has been made explicit, the second member may have a persona that is determined to be compatible, or the like.

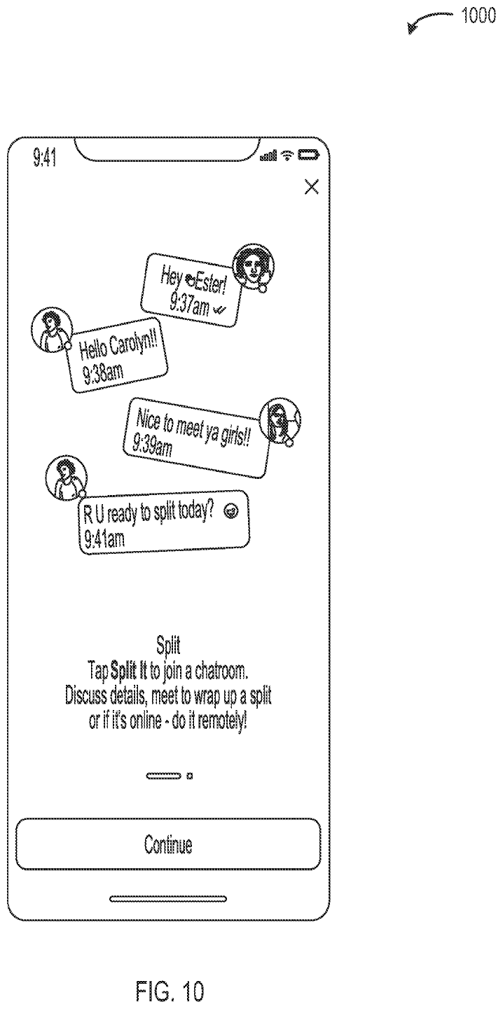

If, on the other hand, it is determined the member (or potential partner) does not create a split (704-N), then the flowchart 700 continues to module decision point 710 where it is determined whether the member (or potential partner) joins a split. A member or potential partner may or may not get split notifications via a map with tagged locations. For example, notifications can come from a notification screen that includes requests to split (as provided by way of example in FIG. 10), from instant messages, from email, from a phone call, or in some other applicable manner.

If it is determined that the member (or potential partner) joins a split (710-Y), then the flowchart 700 continues to module 708 where the member (or potential partner) is directed to the virtual room. If, on the other hand, it is determined that the member (or potential partner) does not join a split (710-N), then the flowchart 700 returns to module 702 and proceeds as described previously. In a specific implementation, entering a virtual room for the first time has an associated cost (which is referred to in the abstract as a coin in this paper); in a specific implementation, the member (or potential partner) can be characterized as paying a coin to join a split. In an alternative, a vendor may pay the coin on behalf of one or more partners. Instead or in addition, the member (or partner) can receive a reward (e.g., a coin) if a partner they invite enters (or a plurality of partners enter) the virtual room.

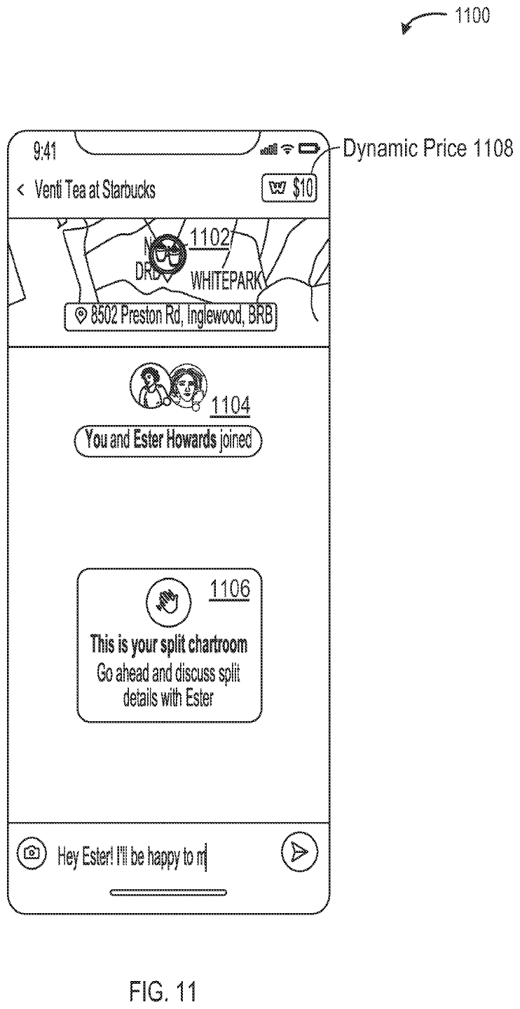

FIG. 11 is a screen shot 1100 of a splash screen that follows joining a split. The screen shot 1100 includes, among other things, the tagged location 1102, an identification of partners 1104, a link to the relevant virtual room 1106, and a dynamic price 1108.

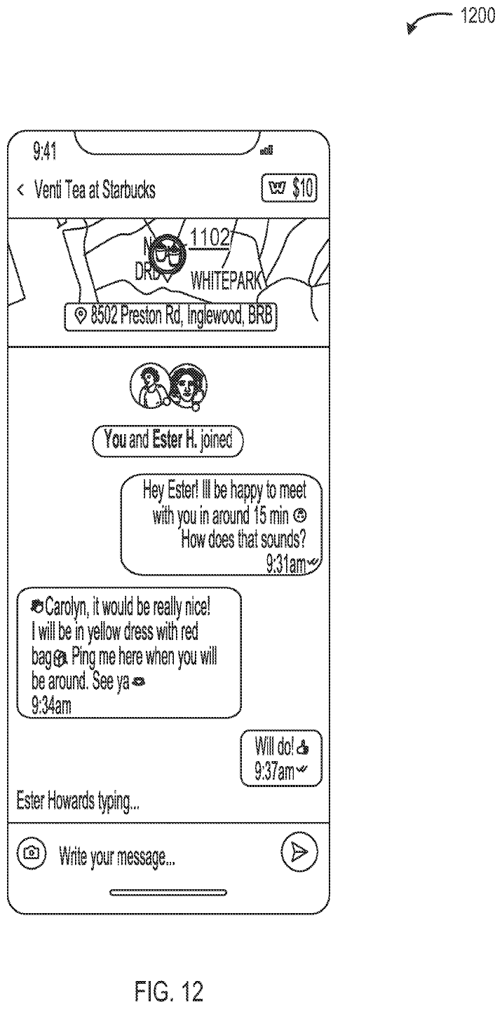

Continuing from module 708 in the example of FIG. 7, the flowchart 700 continues to module 712 with facilitating virtual room interaction. FIG. 12 is a screen shot 1200 of a splash screen that follows joining a split, including virtual room interaction. In this example, FIG. 12 is similar to FIG. 11 (the partner is just able to continue the conversation). In a specific implementation, partners can negotiate dynamic pricing for various parties by adjusting dynamic price 1108. For example, a first partner clicks on the dynamic price 1108, which is $10 in this example, and change it to $9; other members may accept or decline the change. In a specific implementation, a first partner can contribute an asset that stacks with the dynamic price, either bringing the price down for the first partner or bringing the price down for multiple partners. For example, a first partner may have a coupon or a discount card that applies to the entire transaction. Depending upon implementation-, configuration-, and preference-specific factors, a vendor or agent of the economies of scale system may or may not be able to enter a virtual room to offer improved incentives, presents, or the like.

The flowchart 700 continues to module 714 with resolving resource distribution transaction; then the flowchart 700 returns to module 702 and continues are described previously. In a specific implementation, the economies of scale system will track the status of a resource from virtual room creation to resource distribution, though the amount of data collected and maintained can vary. For example, some agreements made in the virtual room may not be treated as part of the transaction by an economies of scale system if partners agree to a deal in chat but whether they went through with the deal is not readily verifiable.

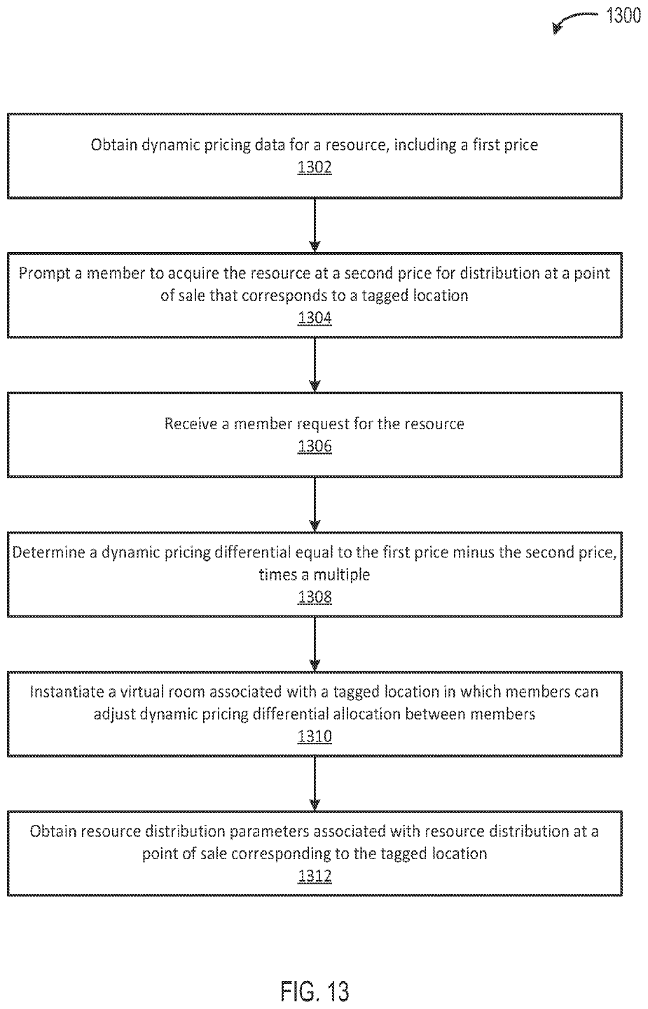

FIG. 13 is a flowchart 1300 of an example of shared dynamic pricing for a resource distributed at a point of sale. The flowchart 1300 starts at module 1302 with obtaining dynamic pricing data for a resource, including a first price. In a specific implementation, obtaining dynamic pricing data for a resource, including a first price is accomplished by a potential resource identification engine, such as the potential resource identification engine 110 of FIG. 1 or the dynamic pricing designation engine 216 of FIG. 2. For illustrative purposes, with reference to FIG. 13, the first price is considered the point of sale (PoS) asking price for a single instance of a resource available at that PoS. It should be noted, however, that a resource could be a bundle of items, such as a package of pencils, a collection of similarly priced items (e.g., in a store that prices all items the same), a campaign (e.g., a shopping spree), or other instance that is priced lower than it would otherwise be priced if more of the instances were sold at the same time.

The flowchart 1300 continues to module 1304 with prompting a member to acquire the resource at a second price for distribution at a PoS that corresponds to a tagged location. In a specific implementation, prompting a member to acquire the resource at a second price for distribution at a PoS that corresponds to a tagged location is accomplished by a resource-to-profile allocation engine, such as the resource-to-profile allocation engine 112 of FIG. 1 or the resource targeting engine 318 of FIG. 3. In an alternative, the member can tag a location if the member is aware of an uncategorized resource, which can obviate the necessity of prompting the member. In this alternative, the second price can be obtained from a coupon of the member, a sale known to the member, or the like. A system for economies of scale aware resource distribution may or may not be aware of the second price until such time as the member makes it aware. Technically, the system for economies of scale aware resource distribution may not even have a record of the second price because the member only shares the information with partners, but because the member is a member of the system, the system as a whole can be characterized as being aware of economies of scale associated with the resource. To the extent it is not clear from context, an economies of scale aware resource distribution engine is aware of the economies of scale associated with the resource when it has a record of the second price, while an economies of scale aware resource distribution system is aware of the economies of scale associated with the resource if it has a record of the second price or if a member is aware of the second price.

In a specific implementation, the prompt includes a map with tagged locations, where the tagged locations are visually identifiable as such and, therefore, distinguishable from locations that are not tagged; the visually identifiable tagged locations “prompt” the member to select them by virtue of their existence. Instead or in addition, a member represented in a profile datastore can be prompted via a notification when a resource represented in a resource datastore is matched to the member. See, e.g., the discussion above with reference to FIG. 3 and FIG. 4. To the extent the profile datastore includes an indication of a persona applicable to the member, the match can be to a persona, as well, but see the discussion above with reference to FIG. 5 for persona-specific notifications. In a specific implementation, prompting a member to acquire the resource at a second price for distribution at a PoS that corresponds to a tagged location is accomplished by a resource-to-persona matching engine, such as the resource-to-persona matching engine 116 of FIG. 1 or the persona-specific notification triggering engine 518 of FIG. 5.

In a specific implementation, the second price can be determined based upon an indication of how many of the resource the member is interested in acquiring (for distribution among partners). For example, a vendor may provide dynamic pricing for a resource that includes different prices for different multiples of the resource such that when a member selects a multiple, the second price can readily be determined from a resource (or vendor) datastore. Instead or in addition, the second price can be provided by a member and matched to a multiple in a similar manner; that is, by looking up a dynamic pricing schedule provided by a vendor. In an alternative, a human or artificial agent can respond to a member's proposed second price by indicating an appropriate multiple or to a member's proposed multiple by indicating a second price.

In some embodiments, a potential partner can be prompted in a manner similar to that of a member, as just described, or receive an invite from a member to join a split. However, a virtual room need not be instantiated when a partner joins. (See module 1308, below.)

The flowchart 1300 continues to module 1306 with receiving a member request for the resource. Continuing the example just described with reference to module 1304, a member or agent thereof can click on or otherwise select a tagged location to express interest in a resource and click or otherwise select an applicable active element to send a member request for the resource. In a specific implementation, receiving a member request for the resource is accomplished by a resource-to-profile allocation engine, such as the resource-to-profile allocation engine 112 of FIG. 1 or the resource targeting engine 318 of FIG. 3 or the resource-to-persona matching engine 116 or the persona-specific notification triggering engine 518 of FIG. 5. See also the discussion above with reference to FIG. 4.

In some embodiments, a partner request is received in a manner similar to that of a member, as just described. However, a virtual room need not be instantiated when a partner request is received. (See module 1308, below.)

The flowchart 1300 continues to module 1308 with determining a dynamic pricing differential equal to the first price minus the second price, times a multiple. Although otherwise similar to that described above for this module 1304, potential partners may or may not be able to acquire the resource at the second price; they may be prompted to acquire the resource at a third price, which may or may not be better than the second price. For the purposes of computing dynamic pricing differentials, however, the first price and the average of the second price and all third prices are used, which corresponds to an undiscounted first price and an actual purchase price at point of sale. This modification is also applicable if partners adjust price among partners in a virtual room. Depending upon the business model of the entity providing the economies of scale infrastructure, the entity may also be allocated a portion of the dynamic pricing differential. Instead or in addition, members pay for the services provided, e.g., when a virtual room is entered.

The flowchart 1300 continues to module 1310 with instantiating a virtual room associated with a tagged location in which members can adjust dynamic pricing differential allocation between members. In a specific implementation, instantiating a virtual room associated with a tagged location in which members can adjust dynamic pricing differential allocation between members is accomplished by an economies of scale engine, such as the economies of scale engine 114 of FIG. 1 or the room creation engine 416 of FIG. 4. The adjustment can include one member acquiring multiple instances of the resource and a larger than that multiple proportion of the differential, a first partner demanding more than a “fair share” than a second partner because they are less willing to pay the full amount (and the second partner is willing to pick up the difference), or the like. In an alternative, dynamic pricing differential allocation follows a predetermined formula that cannot be adjusted by one or more of the partners. (In an alternative in which pricing differential allocation cannot be adjusted at all, the virtual room can still be used as a convenient to communication channel that can be used to coordinate resource distribution.)

The flowchart 1300 continues to module 1312 with obtaining resource distribution parameters associated with resource distribution at a PoS corresponding to the tagged location. In a specific implementation, obtaining resource distribution parameters associated with resource distribution at a PoS corresponding to the tagged location is accomplished by a resource distribution engine, such as the resource distribution engine 118 of FIG. 1 or the resource distribution engine 604 of FIG. 6. It should be noted that resource distribution parameters can be obtained at or between other modules in the flowchart 1300, as resource or profile parameters become available or are attributed to the relevant transaction. A PoS engine can also provide resource distribution parameters.

In a specific implementation, resource distribution parameters include details associated with member (or potential consumer) interest in resources and/or tagged locations (including clicking through a tagged location), member initiation of a virtual room instantiation, partner participation through to resource distribution after joining (including whether a partner fails to follow-through), and other aspects of resource matching and distribution. Resource distribution can include sending resources to partners who are absent at a PoS. Whether details of the PoS transaction can be stored in a resource datastore will depend upon how integrated they PoS is with the system as a whole. That said, in an implementation in which the dynamic pricing differential is shared between an economies of scale system and a vendor, there generally must be some degree of communication related to distribution of the resource.

What is claimed is:

1. A system comprising:
a potential resource identification engine;
a resource-to-profile allocation engine coupled to the potential resource identification engine;
an economies of scale engine coupled to the resource-to-profile allocation engine;
a resource distribution engine coupled to the economies of scale engine;
wherein, in operation:
the potential resource identification engine obtains a dynamic pricing schedule for a resource in association with a tagged location;
the resource-to-profile allocation engine matches the resource to a member;
the economies of scale engine creates a virtual room, associated with the tagged location, in which parties to a transaction involving distribution of the resource can communicate with one another;
the resource distribution engine identifies the member at a point of sale correlated with the tagged location.

2. The system of claim 1 wherein the potential resource identification engine includes:
a vendor onboarding engine configured to collect data associated with a vendor;
a resource deployment scheduling engine configured to obtain resource parameters from the vendor.

3. The system of claim 1 wherein the resource-to-profile allocation engine includes:
a member data collection engine configured to collect data associated with the member;
a resource targeting engine that matches the resource to the member.

4. The system of claim 1 wherein the resource-to-profile allocation engine includes a persona reckoning engine that determines the member has one or more personas.

5. The system of claim 1 wherein the economies of scale engine includes:
a room creation engine that creates the virtual room, associated with the tagged location, in which parties to the transaction involving distribution of the resource can communicate with one another;
a dynamic price differential assignment engine configured to facilitate assignment of savings, from the perspective of a consumer, associated with dynamic pricing price differentials to the member and other parties to distribution of the resource;
a resource allocation engine configured to update a vendor datastore regarding revenue generation attributed to the economies of scale engine.

6. The system of claim 5 wherein the other parties include potential consumers who join the virtual room as partners.

7. The system of claim 5 wherein the other parties include an entity responsible for management of the economies of scale engine.

8. The system of claim 1 comprising a resource-to-persona matching engine that includes:
a persona targeting engine configured to indicate the resource is appropriate for a persona, wherein the member has the persona;
a persona-specific notification triggering engine configured to send a persona-specific notification to the member.

9. The system of claim 1 further comprising a point of sale engine.

10. A method comprising:
obtaining a dynamic pricing schedule for a resource in association with a tagged location;
matching the resource to a member;
creating a virtual room, associated with the tagged location, in which parties to a transaction involving distribution of the resource can communicate with one another;
identifying the member at a point of sale correlated with the tagged location.

11. The method of claim 10 comprising:
collecting data associated with a vendor;
obtaining resource parameters from the vendor.

12. The method of claim 10 comprising:
collecting data associated with the member;
matching the resource to the member.

13. The method of claim 10 comprising determining the member has one or more personas.

14. The method of claim 10 comprising:
facilitating assignment of savings, from the perspective of a consumer, associated with dynamic pricing price differentials to the member and other parties to distribution of the resource;
updating a vendor datastore regarding revenue generation attributed to the economies of scale engine.

15. The method of claim 14 wherein the other parties include potential consumers who join the virtual room as partners.

16. The method of claim 14 wherein the other parties include an entity responsible for management of the economies of scale engine.

17. The method of claim 10 comprising:
indicating the resource is appropriate for a persona, wherein the member has the persona;
sending a persona-specific notification to the member.

18. The method of claim 10 further comprising distributing the resource at the point of sale.

19. A system comprising:
a means for obtaining a dynamic pricing schedule for a resource in association with a tagged location;
a means for matching the resource to a member;
a means for creating a virtual room, associated with the tagged location, in which parties to a transaction involving distribution of the resource can communicate with one another;
a means for identifying the member at a point of sale correlated with the tagged location.
